(19) United States
(12) Patent Application Publication
(10) Pub. No.: US 2007/0076662 A1
(43) Pub. Date: Apr. 5, 2007

(54) Handoffs in a wireless local area network

(76) Inventors: Nikhil Jain, San Diego, CA (US); Rajat Prakash, San Diego, CA (US)

Correspondence Address: QUALCOMM INCORPORATED, 5775 MOREHOUSE DR., SAN DIEGO, CA, 92121, US

(21) Appl. No.: 11/240,901

(22) Filed: Sep. 30, 2005

(51) Int. Cl. H04Q 7/00

(52) U.S. Cl. 370/331; 455/550.1

(57) ABSTRACT

The disclosure is directed to a mobile communication device, and method for handing off a mobile communications device between access points in a Wireless Local Area Network (WLAN). The mobile communications device includes a processor configured to access a database having service quality information for access points in a WLAN, the processor being further configured to use the service quality information in the database to make handoff decisions between the access points. The mobile communications device also includes a transceiver configured to handoff the mobile communications device between the access points based on the handoff decisions made by the processor. The database may be located on a server connected to an IP network, the mobile communications device, or any other suitable location within the WLAN.

### BACKGROUND

1. Field

The present disclosure relates generally to telecommunications, and more particularly, to systems and methods to support handoffs in a Wireless Local Area Network (WLAN).

2. Background

WLANs enable users to roam around a local geographic region while maintaining a connection to a network. Using an air interface, a wired access point may be used to plug any number of wireless devices into the network. The reach of the geographic region covered by a WLAN can be expanded by using multiple access points connected to the same network. By way of example, a number of multiple access points may be distributed within an office building to give employees a seamless network connection as they move throughout the building. WLANs may also be set up in homes allowing multiple users to access one Internet connection. The possibilities for WLANs continue to increase at astronomical rates as technology improves and cost is reduced.

A standard promulgated by the Institute of Electrical and Electronics Engineers (IEEE) called 802.11 or Wi-Fi has substantially contributed to the rapid growth of WLANs. Bluetooth and HomeRF are also WLAN technologies that have gained acceptance in the industry. Bluetooth is generally employed in smaller geographic regions than IEEE 802.11. These smaller geographic regions are generally referred to as Personal Area Networks (PANs). HomeRF, on the other hand, typically has the same geographic reach as IEEE 802.11, but is not as popular as IEEE 802.11. The emergence of these WLAN technologies, as well as others, is the direct results of increased consumer demand for wireless access to network based systems.

To achieve seamless network connectivity as a user roams throughout the WLAN, efficient methods should be employed to handoff the wireless device from one access point to another. These methods should be configured to minimize the delay between handoffs, as well as reduce the failure rate of such handoffs.

### SUMMARY

An aspect of a mobile communications device is disclosed. The mobile communications device includes a processor configured to access a database having service quality information for each access point in a WLAN. The processor is further configured to use the service quality information in the database to make handoff decisions between the access points. The mobile communications device further includes a transceiver configured to handoff the mobile communications device between the access points based on the handoff decisions made by the processor.

Another aspect of a mobile communications device is disclosed. The mobile communications device includes a processor configured to maintain a network connection with a server having a database with service quality information for a plurality of access points in a WLAN. The processor is further configured to access the database and use the service quality information in the database to make handoff decisions between the access points. The mobile communications device further includes a transceiver configured to handoff the mobile communications device between the access points based on the handoff decisions made by the processor.

A further aspect of a mobile communications device is disclosed. The mobile communications device includes memory having a database with service quality information for a plurality of access points in a WLAN. A processor is configured to use the service quality information in the database to make handoff decisions between the access points, and a transceiver configured to handoff the mobile communications device between the access points based on the handoff decisions made by the processor.

Another aspect of a mobile communications device is disclosed. The mobile communications device includes means for accessing a database having service quality information for each access point in a WLAN, means for using the service quality information in the database to make handoff decisions between the access points, and means to handoff the mobile communications device between the access points based on the handoff decisions.

One aspect of a method of handing off a mobile communications device between access points in a WLAN is disclosed. The method includes accessing a database from the mobile communications device, the database having service quality information for each of the access points in the WLAN, and using the service quality information in the database to make a decision whether to handoff the mobile communications device from a first one of the access points to a second one of the access points.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of a wireless communications system are illustrated by way of example, and not by way of limitation, in the accompanying drawings, wherein:

FIG. 1 is a conceptual block diagram of an embodiment of a wireless communications system;

FIG. 2 is a functional block diagram illustrating an example of a mobile device capable of supporting both cellular and WLAN communications; and

FIG. 3 is a flow diagram illustrating the functionality of a processor in a mobile device.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

The various techniques described herein can be implemented with a mobile communications device for a WLAN. The mobile communications device may be any suitable device capable of wireless telephony and/or data communications, such as a wireless telephone. The wireless telephone may be capable of employing any suitable protocol for accessing a WLAN, including, by way of example, IEEE 802.11, Bluetooth, Home RF, or any other WLAN protocol. While these techniques may be applicable to a wireless telephone capable of communicating with a WLAN, those skilled in the art will readily appreciate that these techniques may be extended to other mobile communication devices. For instance, these techniques may be applied to handoffs of mobile communication devices in a cellular network. CDMA2000 1× and GSM are just two examples. Alternatively, these techniques may be extended to mobile communication devices capable of communicating with multiple networks. As will be described in greater detail below, these techniques may be applied to a cellular device capable of communicating with an IEEE 802.11 network. However, any description to a cellular device with IEEE 802.11 capability is intended only to illustrate various aspects of the present invention, with the understanding that these aspects have a wide range of applications.

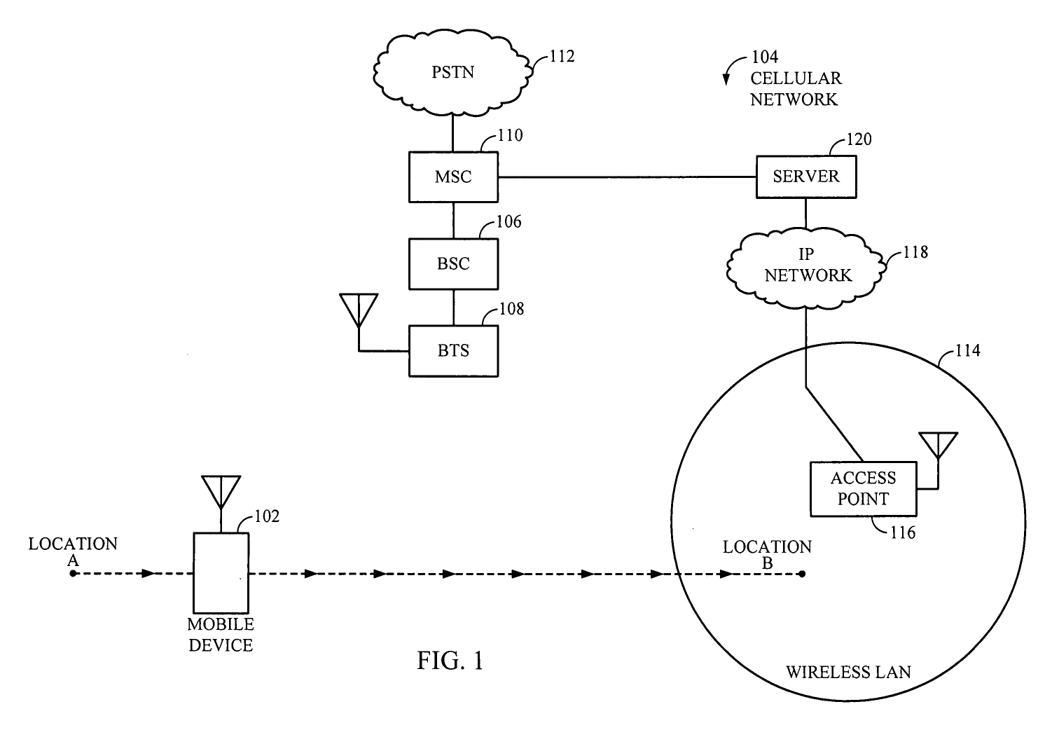

FIG. 1 is a conceptual block diagram of an embodiment of a wireless communications system. A user on a mobile device 102 is shown moving toward and into a WLAN 106 by a series of broken lines. The WLAN 106 may be used in a building that provides network connectivity to the occupants. The WLAN 106 may be an IEEE 802.11 network, or any other suitable network. The WLAN 106 includes a number of access points 108a-108c for the mobile device 102 to communicate with an IP network 110. A server 112 may be used to interface the IP network 110 to a Mobile Switching Center (MSC) 114, which provides a gateway to a Public Switched Telephone Network (PSTN) 116 for telephony applications.

While the user is outside the WLAN 106, the mobile device 102 uses a cellular Wide Area Network (WAN) 120 to support communications. The cellular WAN 120 includes a Base Station Controller (BSC) 122 supporting a number of Base Transceiver Stations (BTS) dispersed throughout the cellular coverage region. A single BTS 124 is shown in FIG. 1 for simplicity of explanation. The BSC 122 communicates with the MSC 114 to provide user access to the PSTN 112, or the IP network 110. Although not shown in FIG. 1, the cellular WAN 120 may employ numerous BSCs each supporting any number of BTSs to extend the geographic reach of the cellular WAN 116. When multiple BSCs are employed throughout the cellular WAN 120, the MSC 114 may also be used to coordinate communications between the BSCs.

The mobile device 102 may access the cellular WAN 120 by acquiring a pilot signal from the BTS 124. Once the pilot signal is acquired, a radio connection may be established between the mobile device 102 and the BTS 124 by means well known in the art. The mobile device 102 may use the radio connection with the BTS 124 to register with the MSC 114. Registration is the process by which the mobile device 102 makes its whereabouts known to the cellular WAN 120. When the registration process is complete, the mobile device 102 may enter into an idle state until a call is initiated. The call may be initiated by the mobile device 102, or received from the PSTN 116 or the IP network 110. Either way, an air traffic link may be established between the mobile device 102 and the BTS 124 to set up and support the call.

The mobile device 102 may be configured to periodically search for a beacon to locate a WLAN. A beacon is a periodic signal transmitted by each access point in a WLAN. As shown in FIG. 1, the mobile device 102 may begin to detect a beacon from one or more access points as the user approaches or enters the WLAN 106. In a manner to be described in greater detail later, the mobile device 102 selects an access point to establish a radio connection. The radio connection may be established by means well known in the art. The mobile device 102 also then obtains the IP address of the server 112. The mobile device 102 may use the services of a Domain Name Server (DNS) to determine the server's IP address. The domain name of the server 112 may be delivered to the mobile device 102 over the cellular WAN 120. With the IP address, the mobile device 102 can establish a network connection with the server 112. Once the network connection is established, the user may use the mobile device 102 to access the PSTN 116 for telephony applications or the IP network 110 for data communications.

As the user roams through the WLAN 106, the mobile device 102 may be handed off between access points 108a-108c to maintain network connectivity. The decision to handoff the mobile device 102 from one access point to another may be based on a variety of factors. In at least one embodiment of the WLAN 106, a central database may be maintained by the server 112 with service quality information relating to each access point. The service quality information may include historical information about each access point, such as the rate of dropped calls, the rate of handoff failures, and the peak traffic hours. The service quality information may also include quality metrics relating to the network connection through each access point such as the data error rate. The “data error rate” may take the form of the bit-error-rate (BER), frame-error-rate (FER), packet-error-rate, or any other error rate measurement which indicates whether information transmitted over the network connection is corrupted. The mobile device 102 may use the service quality information in conjunction with the signal strength of the beacon from each access point 108a-108c to make intelligent handoff decisions, and thereby reduce the failure rate of handoffs within the WLAN 106.

In telephony applications, the quality metrics may also include delay, jitter or packet loss over the network connection through each access point. These metrics may be a good indication of the call quality a user on a mobile device can expect to receive. By way of example, excessive delay may result in poor quality due to undesirable echoes or talker overlap. The problems with delay may be further compounded by the need to remove jitter. Jitter is the variation in the delay of packets due to network congestion, timing drift, or route changes. Lost packets can be especially problematic in telephony applications. Because IP networks do not guarantee service, they will usually exhibit a high incidence of lost packets. In IP networks, voice packets are treated the same as data. As a result, voice packets will be dropped equally with data packets when the IP network is heavily congested. Unlike data packets, however, lost voice packets cannot be simply retransmitted at a later time.

The centralized database may also be used to maintain a list of neighboring access points for each access point in the WLAN 106. Associated with each neighboring access point listed is the operating channel, i.e., frequency band. The mobile device 102 may use the list to reduce the search time for a new access point by searching only those channels where a neighboring access point is known to exist.

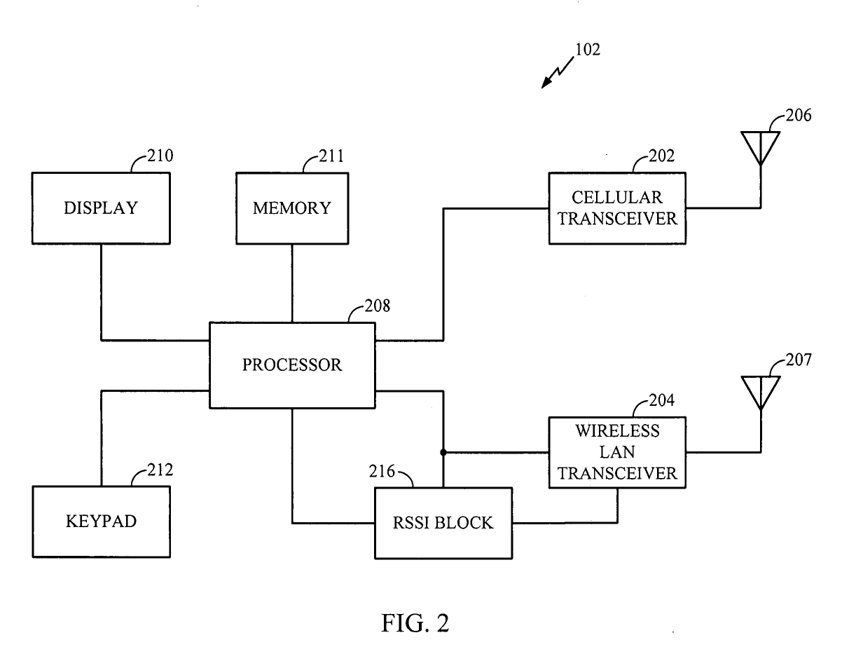

FIG. 2 is a functional block diagram illustrating an example of a mobile device capable of supporting both cellular WAN and WLAN communications. The mobile device 102 may include a cellular transceiver 202 and a WLAN transceiver 204. In at least one embodiment of the mobile device 102, the cellular transceiver 202 is capable of supporting CDMA2000 1× communications with a BTS (not shown), and the WLAN transceiver 204 is capable of supporting IEEE 802.11 communications with an access point (not shown). Those skilled in the art will readily appreciate, however, that the concepts described in connection with the mobile device 102 can be extended to other cellular and WLAN technologies, either alone or in combination with one another. By way of example, a single WLAN transceiver may be employed under processor control in a mobile device dedicated to IEEE 802.11 communications. In a cellular mobile device with IEEE 802.11 capability, each transceiver 202, 204 may have a separate antenna 206, 207, respectively, as shown, but the transceivers 202, 204 could share a single broadband antenna. Each antenna 206, 207 may be implemented with one or more radiating elements.

The mobile device 102 is also shown with a processor 208 coupled to both transceivers 202, 204, however, a separate processor may be used for each transceiver in alternative embodiments of the mobile device 102. The processor 208 may be implemented as hardware, firmware, software, or any combination thereof. By way of example, the processor 208 may include a microprocessor (not shown). The microprocessor may be used to support software applications that, among other things, (1) control and manage access to the cellular WAN and WLAN, and (2) interface the processor 208 to the keypad 210, display, 212, and other user interfaces (not shown). The processor 208 may also include a digital signal processor (DSP) (not shown) with an embedded software layer that supports various signal processing functions, such as convolutional encoding, cyclic redundancy check (CRC) functions, modulation, and spread-spectrum processing. The DSP may also perform vocoder functions to support telephony applications. The processor 208 may be a stand-alone entity or distributed across multiple entities in the mobile device 102. The manner in which the processor 208 is implemented will depend on the particular application and the design constraints imposed on the overall system. Those skilled in the art will recognize the interchangeability of hardware, firmware, and software configurations under these circumstances, and how best to implement the described functionality for each particular application.

Referring to FIGS. 1 and 2, the mobile device 102 may be configured to periodically search for a beacon from an access point in a WLAN as the user travels through the WAN 120. In one embodiment, the mobile device 102 is configured to establish a radio connection with the first access point in a WLAN it detects with sufficient beacon signal strength. If the mobile device 102 detects multiple access points as it approaches a WLAN, it may establish a network connection with the access point having the strongest beacon. The signal strength of the beacon for one or more access points in a WLAN may be determined with a Received Signal Strength Indicator (RSSI) block 216. The RSSI is most likely an existing signal that is fed back to the WLAN transceiver 204 for automatic gain control, and therefore, can be provided to the processor 208 without increasing the circuit complexity of the mobile device. Alternatively, the signal strength of the beacon from each access points may be determined by the processor 208. Since the beacon is a spread-spectrum signal that is known, a priori, a replica of the beacon can be stored in memory 209 at the mobile device 102. The demodulated beacon may be correlated with the replica beacon stored in memory 209 to estimate the energy of the transmitted beacon by means well known in the art.

Once a radio connection is established, the processor 208 may establish a network connection with the server 112 as described in greater detail earlier. The processor 208 may then be used to compute various quality metrics relating to the network connection in the forward direction. The term “forward direction” refers to transmissions from the server 112 to the mobile device 102, and the term “reverse direction” refers to transmissions from the mobile device 102 to the server 112. In the description of the embodiments to follow, the quality metrics may include delay, jitter, lost packets, and data rate error, but can be any type of quality metrics relating to the forward direction network connection. These metrics may be transmitted from the mobile device 102 to the server 112 over the network connection. The server 112 uses these metrics to update the information in the centralized database. In addition, the server 112 may also compute various quality metrics of its own relating to the network connection in the reverse direction, and use these metrics to further update the information in the centralized database.

The processor 208 may compute the delay across the network connection in the forward direction by any suitable means. In at least one embodiment of the WLAN 106, date and time stamps may be used with packets transmitted from the server 112 to measure delay across the network connection. More specifically, when a forward direction transmission is received by the mobile device 102, the time stamp can be extracted in the processor 208 and compared to a local clock internal (not shown) in the mobile device 102. The result, which represents the delay over the network connection in the forward direction, may be transmitted back to the server 112 to update the centralized database.

The use of time stamps to measure delay across the network connection requires that the local clock be synchronized with the server 112. A remote time source (not shown) may be used to synchronize the mobile device 102 to the server 112. The remote time source may be one of numerous servers in the IP network 110 that are synchronized to Universal Time Coordinated (UTC) via radio, satellite, modem, or other means. The remote time source may be used to provide time information to update or synchronize the internal clock in the mobile device 102. This may be achieved with a software program known as Network Time Protocol (NTP). NTP is an Internet standard protocol for synchronizing clocks to some time reference. NTP may be run in the processor 208, or elsewhere in the mobile device 102.

The processor 208 may be further configured to measure the jitter over the network connection in the forward direction as an additional quality metric. In the case of an adaptive jitter buffer, which adapts to changes in the network's delay, the delay measured by the algorithm may include network jitter, depending on where the measurement is made in the processing path. In the case of a fixed jitter buffer, which introduces a fixed delay to the packet, the processor may measure the network jitter from the variations in the delay values. In any event, the jitter value may be transmitted back to the server 112 to update the centralized database.

The processor 208 may also be used to compute a quality metric relating to lost packets by any suitable means. By way of example, packets transmitted from the server 112 can also include sequence numbers, in addition to time and date stamps. When the forward direction transmission is received by the mobile device 102, the sequence numbers can be extracted in the processor 208 and used by the algorithm. Based on the sequence numbers, the algorithm can determine which packets have been lost. The number of lost packets can be transmitted back to the server 112 to update the centralized database.

As discussed earlier, various signal processing functions may be performed by the processor 208 such as convolutional encoding, CRC functions, modulation, and spread-spectrum processing. The CRC function may also be used by the processor 208 to compute the FER by means well known in the art. The FER may be transmitted back to the server 112 to update the centralized database.

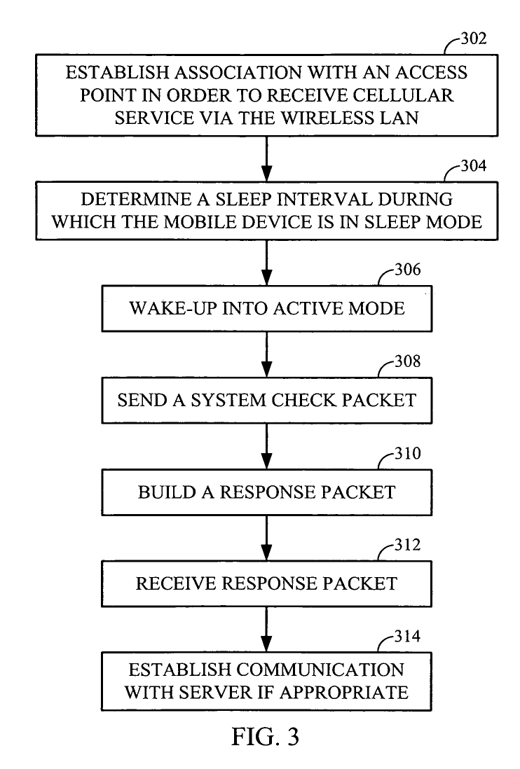

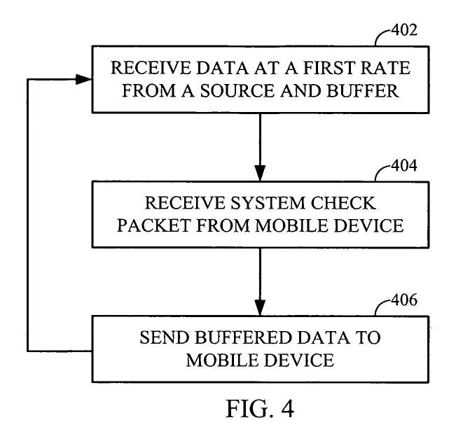

FIG. 3 is a flow diagram illustrating the functionality of the processor in managing and controlling handoffs between access points as the user roams throughout the WLAN. In step 302, the mobile device begins to detect one or more beacons from the access points as the user approaches or enters the WLAN. The signal strength of the beacons may be determined by the WLAN transceiver or the processor by means discussed in greater detail earlier. A radio connection may then be established between the WLAN transceiver and the access point with the strongest beacon. This access point will be referred to as the “base access point. ”Once a radio connection is established, the processor may establish a network connection with the server in step 304. The processor may also register, in step 306, with the MSC through the IP network to ensure that all calls destined for the mobile device are routed through the WLAN (see FIG. 1). If the processor is supporting an active call, then the MSC may be used to handoff the call from the WAN to the WLAN.

In step 308, the processor uses the network connection to access the database in the server to identify the access points in the neighbor list for the base access point. The access points contained in the neighbor list will be referred to as “candidate access points. ”In step 310, the processor continuously, or periodically, monitors the service quality information for the base and candidate access points. The service quality information may change with time as the loading, dropped call rate, and peak traffic patterns change. In addition, quality metric updates from all mobile devices using the base and candidate access points may also cause the service quality information to change with time.

In step 312, the processor measures the varying signal strength of the beacons for the base and candidate access points as the user roams through the WLAN. This may be achieved by sweeping the tuner in the WLAN transceiver through the operating frequencies of the candidate access points when the mobile device is sleeping. In the event that the processor is supporting an active call, appropriate buffering may be used at the server and the mobile device to allow the WLAN transceiver to periodically measure the beacons from the candidate access points.

In step 314, the processor determines whether or not to handoff the mobile device from the base access point to a candidate access point. The handoff decision may be based on the beacon measurements and the service quality information for the base and candidate access points. The specific algorithm used to make a handoff decision may vary. By way of example, the algorithm could be implemented to first determine the strongest beacon between the base and candidate access points. Should a candidate access point have the strongest beacon, the processor may then handoff the mobile device to that candidate access point if certain conditions are met. These conditions could be minimum threshold levels for certain quality metrics such as delay, jitter, lost packets or data error rate. Alternatively, the quality metrics for the candidate access point with the strongest beacon may be compared with the same quality metrics for the base access point, basing a handoff decision on the relative quality of the network connection between the two access points. The relative strengths of the beacons from the candidate and base access point can also be factored into the equation. The loading, dropped call rate and peak traffic patterns may also be used by the processor to determine whether to handoff the mobile. In some embodiments, the processor may handoff the mobile to a candidate access point whose beacon is not the strongest, but who can provide the highest quality network connection. The loading on a candidate access point can provide an absolute bar to handoff when it reaches a maximum threshold, or alternatively be merely a factor in the handoff decision. Peak traffic patterns may be used to make handoff decisions that more uniformly distribute the load across the WLAN. Those skilled in the art will be readily able to determine the appropriate algorithm for any particular application depending upon the performance requirements and the overall design constraints imposed on the system.

Should the processor determine that the radio connection between the mobile device and the base access point remain in tact, the algorithm loops back to step 308 to access the centralized database and continue monitoring the service quality information for the candidate access points. Alternatively, if the processor determines that the mobile device should be handed off to a candidate access point, the algorithm loops back to step 306 to register with the MSC. Through the registration process, the MSC is alerted to route all calls to the mobile device through the candidate access point once handoff is completed.

In an alternative embodiment, a centralized database of service quality information may be maintained in the memory 209 of the mobile device 102 (see FIG. 2). Returning to FIG. 1, the mobile device 102 establishes a network connection with the server 112 when the user approaches or enters the WLAN 106. Once the network connection is established, the service quality information and neighbor list for each access point may be downloaded from the server 112 to the mobile device 102. Alternatively, the neighbor list for each access point could be pre-provisioned into the mobile device 102. The mobile device 102 may use the service quality information and neighbor lists to create a centralized database to support intelligent handoff decisions within the WLAN 106.

As the mobile device 102 continues to operate with the VWLAN 106, it receives from the server 112 historical information and quality metrics relating to each access point 108a-108c. The historical information may include loading, dropped call rates, and peak traffic patterns for the access points, and the quality metrics may include data error rate, delay, jitter and lost packets for the reverse direction network connection. This information may be used to update the centralized database in the mobile device 104. In addition, the mobile device 102 may also compute various quality metrics of the forward direction network connection to further update the centralized database. These quality metrics for the forward direction network connection may also be transmitted to the server 112 to be used by other mobile devices in the WLAN 106 to determine the quality of the network connection through the access point in communication with mobile device 102.

The various illustrative logical blocks, modules, circuits, elements, and/or components described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more. ”All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for. ”

What is claimed is:

1. A mobile communications device, comprising:
a processor configured to access a database having service quality information for each access point in a WLAN, the processor being further configured to use the service quality information in the database to make handoff decisions between the access points; and
a transceiver configured to handoff the mobile communications device between the access points based on the handoff decisions made by the processor.

2. The mobile communications device of claim 1 wherein the processor is further configured to maintain a network connection with a server, the database being located on the server.

3. The mobile communications device of claim 1 further comprising memory having the database.

4. The mobile communications device of claim 1 wherein the service quality information includes delay, jitter, lost packet, or data error rate information for each of the access points.

5. The mobile communications device of claim 4 wherein the processor is further configured to update said delay, jitter, lost packet, or data error rate information for one of the access points when the transceiver has a radio link with said one of the access points.

6. The mobile communications device of claim 1 wherein the service quality information includes loading, dropped call rate, or peak traffic information for each of the access points.

7. The mobile communications device of claim 1 wherein the database further includes a neighbor list for each of the access points.

8. The mobile communications device of claim 7 wherein the processor is further configured use the service quality information only for the access points in the neighbor list of one of the access points to make a handoff decision when the transceiver has a radio link with said one of the access points.

9. The mobile communications device of claim 1 wherein the database includes service quality information for a plurality of access points in a second WLAN, the processor being further configured to use the service quality information to make a handoff decision from one access point in the WLAN to another access point in the second WLAN.

10. The mobile communications device of claim 1 further comprising a second transceiver configured to maintain a radio link with a base station in a cellular WAN, the processor being further configured to support communications over the radio link.

11. A mobile communications device, comprising:
a processor configured to maintain a network connection with a server having a database with service quality information for a plurality of access points in a WLAN, the processor being further configured to access the database and use the service quality information in the database to make handoff decisions between the access points; and
a transceiver configured to handoff the mobile communications device between the access points based on the handoff decisions made by the processor.

12. The mobile communications device of claim 11 wherein the service quality information includes delay, jitter, lost packet, or data error rate information for each of the access points.

13. The mobile communications device of claim 12 wherein the processor is further configured to update said delay, jitter, lost packet, or data error rate information for one of the access points when the transceiver has a radio link with said one of the access points.

14. The mobile communications device of claim 11 wherein the service quality information includes loading, dropped call rate, or peak traffic information for each of the access points.

15. The mobile communications device of claim 11 wherein the database further includes a neighbor list for each of the access points.

16. The mobile communications device of claim 15 wherein the processor is further configured use the service quality information only for the access points in the neighbor list of one of the access points to make a handoff decision when the transceiver has a radio link with said one of the access points.

17. A mobile communications device, comprising:
memory having a database with service quality information for a plurality of access points in a WLAN;
a processor configured to use the service quality information in the database to make handoff decisions between the access points; and
a transceiver configured to handoff the mobile communications device between the access points based on the handoff decisions made by the processor.

18. The mobile communications device of claim 17 wherein the service quality information includes delay, jitter, lost packet, or data error rate information for each of the access points.

19. The mobile communications device of claim 18 wherein the processor is further configured to update said delay, jitter, lost packet, or data error rate information for one of the access points when the transceiver has a radio link with said one of the access points.

20. The mobile communications device of claim 17 wherein the service quality information includes loading, dropped call rate, or peak traffic information for each of the access points.

21. The mobile communications device of claim 17 wherein the database further includes a neighbor list for each of the access points.

22. The mobile communications device of claim 21 wherein the processor is further configured use the service quality information only for the access points in the neighbor list of one of the access points to make a handoff decision when the transceiver has a radio link with said one of the access points.

23. A mobile communications device, comprising:
means for accessing a database having service quality information for each access point in a WLAN;
means for using the service quality information in the database to make handoff decisions between the access points; and
means to handoff the mobile communications device between the access points based on the handoff decisions.

24. A method of handing off a mobile communications device between access points in a WLAN, comprising:
accessing a database from the mobile communications device, the database having service quality information for each of the access points in the WLAN; and
using the service quality information in the database to make a decision whether to handoff the mobile communications device from a first one of the access points to a second one of the access points.

25. The method of claim 24 further comprising handing off the mobile communications device from the first one of the access points to the second one of the access points.

26. The method of claim 24 further comprising maintaining a network connection with a server through the first one of the access points, and wherein the database is accessed over the network connection.

27. The method of claim 24 wherein the database resides in memory in the mobile communications device.

28. The method of claim 24 wherein the service quality information includes delay, jitter, lost packet, or data error rate information for each of the access points.

29. The method of claim 28 further comprising update said delay, jitter, lost packet, or data error rate information for the first one of the access points while a radio link exists with the first one of the access points.

30. The method of claim 24 wherein the service quality information includes loading, dropped call rate, or peak traffic information for each of the access points.

31. The method of claim 24 wherein the database further includes a neighbor list for each of the access points, the neighbor list for the first one of the access points including the second one of the access points.

32. The method of claim 31 wherein the service quality information is used only for the access points in the neighbor list of the first one of the access points when making a decision whether to handoff from the first one of the access points to the second one of the access points.
